(19) United States
(12) Patent Application Publication
(10) Pub. No.: US 2011/0061258 A1
(43) Pub. Date: Mar. 17, 2011

(54) VALVE EXHAUSTING APPARATUS AND A DRIER OF FOOD TREATMENT SYSTEM HAVING IT

(75) Inventors: Sung Jin Kim, Seoul (KR); Sang Gu Sim, Goyang-si (KR); Chan Jung Park, Suwon-si (KR)

(73) Assignee: WOONGJIN COWAY CO., LTD., Gongju-si (KR)

(21) Appl. No.: 12/921,136

(22) PCT Filed: Sep. 4, 2008
(86) PCT No.: PCT/KR2008/005217

§ 371 Date: Nov. 29, 2010

(30) Foreign Application Priority Data
Mar. 18, 2008 (KR) 10-2008-0024967
Aug. 26, 2008 (KR) 10-2008-0083564

(51) Int. Cl. F26B 11/02

(52) U.S. Cl. 34/108

(57) ABSTRACT

An exhaust valve apparatus and a drier of a food treatment system having the exhaust valve apparatus are disclosed. The drier includes a drum having an input port and a discharge port. A stirring screw is rotatably disposed in inner space of the drum, and includes rotary blades for stirring and crushing food waste put into the drum and a rotating shaft for supporting the rotary blades. A power supply unit is provided on a surface of the drum and provides power to the stirring screw to rotate the stirring screw. A heater is provided on the outer surface of a drum body and provides high temperature heat to the inner space of the drum when electric power is applied to the heater, thus drying the food waste. An exhaust apparatus is mounted to the lower surface of the discharge port and controls the discharge port.

### TECHNICAL FIELD

The present invention relates, in general, to a drier of a food treatment system having an exhaust valve apparatus and, more particularly, to a drier of a food treatment system having an exhaust valve apparatus, which allows a dried food waste to be easily cut and discharged to the outside, and enables the discharged food waste to be evenly dispersed.

### BACKGROUND ART

Generally, in order to dispose of a food waste, a fermentation treatment method, an incineration treatment method, a method of recycling food waste as feed or fertilizer (manure), a method of putting food waste in a landfill, and other methods are used. However, the above-mentioned methods require large facilities, may generate offensive odors or lead to inconveniences of collection, conveyance or storage of food waste, and may cause serious social problems such as environmental pollution.

Therefore, there has been an urgent demand for a method of reducing environmental pollution resulting from food waste and recycling the food waste.

Meanwhile, although the total number of households in Korea has passed ten million households, measures for the disposal of food waste which may cause environmental pollution are not yet sufficient. The main cause of the insufficient measures is due to the housewives' lack of understanding of the waste of resources and of environmental pollution.

Thus, in order to reduce the amount of food waste and efficiently recycle the food waste, there is a pressing need for the development of a food treatment system for home use which overcomes the above-mentioned problems.

Generally, a food treatment system which is connected to a sink of a home to dispose of food waste performs a series of processes, including dehydrating, cutting, and drying processes, thus removing water from the food waste and reducing the volume of the food waste, therefore dramatically reducing the discharged amount of the food waste.

Each of the conventional food treatment systems which is attached to a sink to dispose of food waste or an individual free standing type food treatment system includes an input port into which food waste is put, a dehydrating/cutting unit which compresses the food waste to dehydrate it and cut it into small pieces, a feeding unit which feeds the dehydrated and cut food waste to one side, a drier which evenly churns and disperses the dehydrated and cut food waste using a rotary blade rotated in one direction by a motor and removes water from the food waste using the high temperature heat, and a discharge box which stores the food waste which has been discharged after being dried.

Meanwhile, after the remaining water has completely removed from the food waste using the high temperature heat of the drier, the entirety of food waste is discharged through a discharge port which is bored through the bottom of the drier. After the entirety of food waste has been discharged from the drier, food waste which was dehydrated and cut by the dehydrating/cutting unit is continuously put into the drier, so that the operation of drying the food waste is performed repeatedly.

However, when the food waste put into the drier contains a large amount of starch or water, the viscosity of the food waste which is stirred and crushed by the rotary blade is high, so that the food waste may be accumulated around the discharge port and thereby the discharge port may become clogged.

Particularly, the accumulated food decays, so that the surroundings of the drier may be contaminated, and the drier of the food treatment system may become damaged.

### DISCLOSURE OF INVENTION

### Technical Problem

Accordingly, the present invention has been made keeping in mind the above problems occurring in the prior art, and an object of the present invention is to provide an exhaust valve apparatus which allows dried food waste to be easily cut and discharged to the outside, and enables the discharged food waste to be evenly scattered, and to provide a drier of a food treatment system having the exhaust valve apparatus.

### Technical Solution

In order to accomplish the above object, the present invention provides a food waste exhaust apparatus for a food treatment system including a valve unit provided in a discharge port of the food treatment system to open or close the discharge port; a power supply unit for supplying power to the valve unit to open or close the valve unit; and a power transmission member provided between the power supply unit and the valve unit, for transmitting power supplied from the power supply unit to the valve unit.

The power transmission member is a rolling contact unit or a shaft unit.

The rolling contact unit is a gear.

The valve unit comprises a shaft valve member.

the valve unit is operated rotably by the power transmitted to the valve unit.

the valve unit is operated rotably in a vertical or horizontal direction relative to the power transmission member.

the power supply unit is a motor.

The food waste exhaust apparatus further includes a sensor unit for detecting a position of the valve unit.

In order to accomplish the above object, the present invention provides a drier for a food treatment system including a drum having an input port into which food waste is put and a discharge port through which dried food waste is discharged; a stirring screw rotatably disposed in inner space of the drum, and including rotary blades for stirring and crushing the food waste put into the drum, and a rotating shaft for supporting the rotary blades; a power supply unit provided on a side of the drum and providing power to the stirring screw to rotate the stirring screw; a heater provided on an outer side of a drum body and providing high temperature heat to an inner space of the drum when electric power is applied to the heater, thus drying the food waste; and an exhaust apparatus mounted to a lower surface of the discharge port and controlling opening and closing of the discharge port.

The drier further includes a crush unit provided on an inner wall of the drum to which the power supply unit and the stirring screw are connected, the crush unit including a circular crush plate having a plurality of crush blades which are obliquely provided on the circular crush plate in a radial direction thereof, and an arch-shaped crush plate support provided on an upper portion of the crush plate.

The crush plate support includes a circular plate member provided to surround the crush plate, and a rib member provided on an outer surface of the plate member in a radial direction thereof.

The rotary blades each have a hook shape and are arranged such that ends thereof face each other, with a space defined between the rotary blades.

the rotary blades are detachably provided on a circumference of the rotating shaft.

The exhaust apparatus includes a valve unit provided in the discharge port of the food treatment system to open or close the discharge port; a power supply unit for supplying power to the valve unit to open or close the valve unit; and a power transmission member provided between the power supply unit and the valve unit, and transmitting power supplied from the power supply unit to the valve unit.

The power transmission member is a rolling contact unit or a shaft unit.

The rolling contact unit is a gear.

The valve unit comprises a shaft valve member.

the valve unit is operated rotably in a vertical or horizontal direction relative to the power transmission member.

the power supply unit is a motor.

The shaft valve member includes a support shaft having a shape of a rod which has a circular section, a valve having a diameter larger than that of the support shaft and having a shape of a rod which has a semi-circular section and connected at a first end thereof to a first end of the support shaft, and a cam fitted over a second end of the support shaft and having on a surface thereof a protrusion.

The valve is formed by sintering a Teflon material.

The valve is coated with Teflon.

a thickness of the valve is in the range of 1˜3 mm.

The drier further includes a valve cover having a shape of a ring having a semi-circular section, and having a valve receiving cavity to surround a curved part of the valve, with a fastening part provided on an inner side of the valve receiving cavity; and a locking cover having on both ends thereof semi-circular concave grooves to receive the support shaft and the valve, and having in a central portion thereof an opening portion to correspond to the discharge port.

The valve cover is formed by sintering a Teflon material.

The valve cover is coated with Teflon.

a thickness of the valve cover is in the range of 1˜3 mm.

The drier further includes a bushing member provided on each of opposite ends of the shaft valve member.

The power transmission member includes a gear mounted on a drive shaft of a power supply unit and at least one driven gear operatively engaging with the drive gear, and a gear insert part provided on an end of the support shaft is inserted into a center of the driven gear, so that the shaft valve member is driven rotably clockwise or counter-clockwise according to rotation of the drive gear and the driven gear.

The drier further includes a sensor unit having a sensor for detecting contact pressure with the protrusion of the cam during rotation of the cam, and a bracket for supporting the sensor.

### ADVANTAGEOUS EFFECTS

According to the present invention, a drier of a food treatment system having an exhaust valve apparatus allows dried food waste to be easily cut prior to being discharged to the outside, thus preventing the food waste from accumulating and from decaying, therefore keeping the surroundings of the drier clean and preventing damage to the drier. Further, the drier of the present invention permits the discharged food waste to be evenly dispersed, thus preventing the discharged food waste from collecting in only one place.

### BRIEF DESCRIPTION OF DRAWINGS

FIG. 1 is a front top perspective view illustrating a drier 100 of a food treatment system according to one embodiment of the present invention,

FIG. 2 is a rear top perspective view illustrating the drier 100 of the food treatment system of FIG. 1,

FIG. 3 is a bottom perspective view illustrating the drier 100 of the food treatment system of FIG. 1,

FIG. 4 is a side view illustrating the drier 100 of the food treatment system of FIG. 1,

FIG. 5 is a perspective view illustrating a crush unit 160 of the drier 100 of the food treatment system according to one embodiment of the present invention,

FIG. 6 is a perspective view illustrating parts around a discharge port of the drier 100 of the food treatment system according to one embodiment of the present invention,

FIG. 7 is a bottom exploded perspective view illustrating the drier 100 of the food treatment system according to one embodiment of the present invention,

FIG. 8 is an exploded perspective view illustrating an exhaust valve apparatus according to one embodiment of the present invention, and

FIG. 9 is a sectional view illustrating the exhaust valve apparatus, with the discharge port 114 open.

### MODE FOR THE INVENTION

The above and other objects, features and advantages of the present invention will be more clearly understood from the following detailed description taken in conjunction with the accompanying drawings. Hereinafter, a drier 100 of a food treatment system having an exhaust valve apparatus according to the preferred embodiment of the present invention will be described in detail with reference to the accompanying drawings.

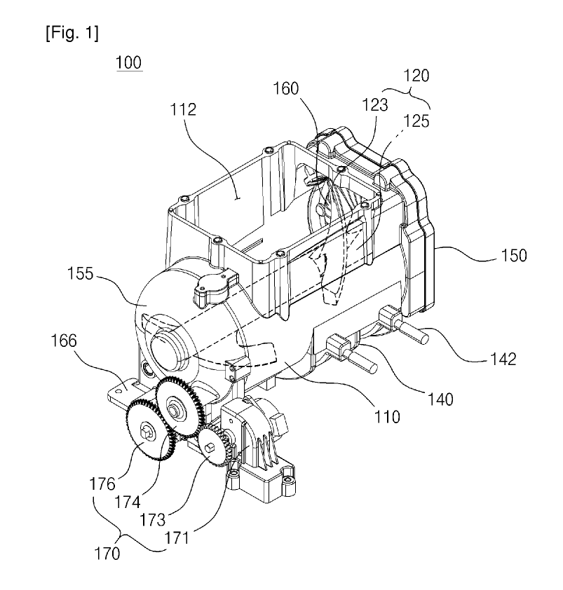

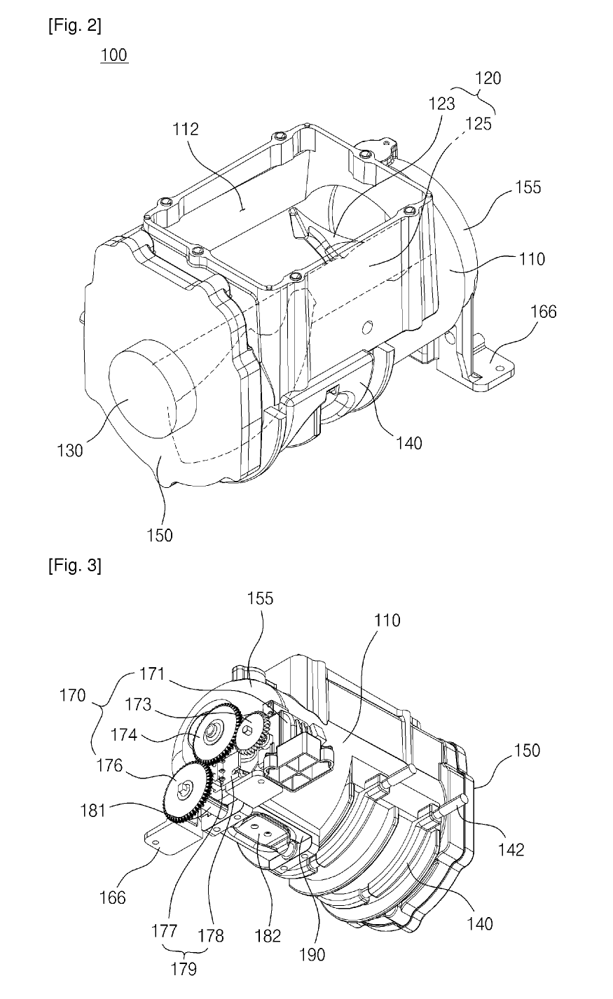

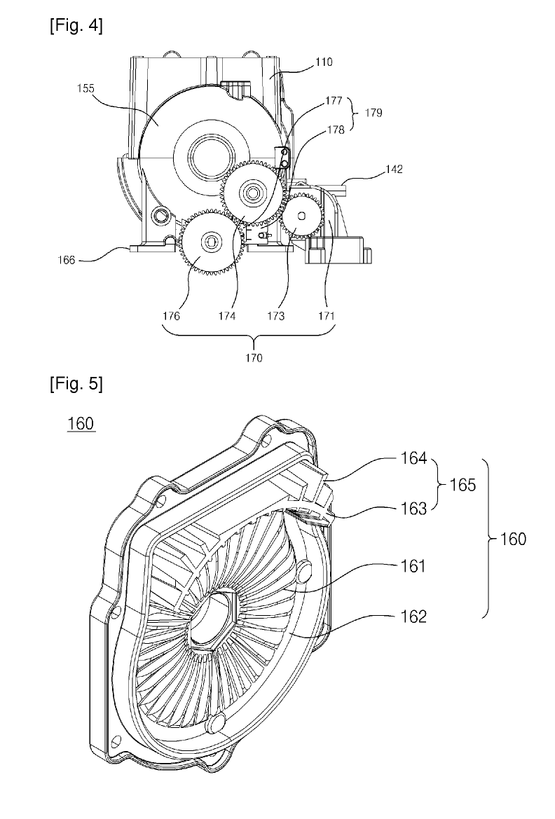

FIG. 1 is a front top perspective view illustrating a drier 100 of a food treatment system according to one embodiment of the present invention, FIG. 2 is a rear top perspective view illustrating the drier 100 of the food treatment system of FIG. 1, FIG. 3 is a bottom perspective view illustrating the drier 100 of the food treatment system of FIG. 1, and FIG. 4 is a side view illustrating the drier 100 of the food treatment system of FIG. 1.

Referring to FIGS. 1 to 4, the drier 100 of the food treatment system having the exhaust valve apparatus according to one embodiment of the present invention includes a cylindrical drum 110, a stirring screw 120, a power supply unit 130, a heater 140, and an exhaust valve apparatus. The cylindrical drum 110 is provided with an input port 112 into which dehydrated food waste is input, and an elliptical discharge port 114 which is oriented in the axial direction of the drum to discharge the dried food waste. The stirring screw 120 is rotatably positioned in the drum 110, and is provided with a plurality of rotary blades 123 which stir and crush the food waste input into the drum 110 and a rotating shaft 125 which supports the rotary blades 123. The power supply unit 130 is provided on one end of the drum 110 and provides power to the stirring screw 120, rotating the stirring screw. The heater 140 is provided on the outer surface of the body of the drum 110 and provides high temperature heat to the interior of the drum 110 when electricity is applied to the heater, thus drying the food waste. The exhaust valve apparatus is mounted to the lower surface of the elliptical discharge port which is formed in the axial direction, and opens or closes the elliptical discharge port according to the drying state in the drum 110.

The drier 100 of the food treatment system according to the present invention functions to leave some of the completely dried food waste on the bottom in the drying space so as to be mixed with food waste which is continuously input into the drier, thus reducing the viscosity of all food waste in the drying space.

The drum 110 is provided with the input port 112 which is formed in the upper surface of the drum body, and the elliptical discharge port 114 (see FIG. 7) which is axially formed in the bottom of the drum body. The drum is the hollow cylindrical holding member which has an internal space of a predetermined size to hold a predetermined amount of food waste.

The drum may have the external appearance of a hexahedron, sphere or other shapes. The discharge port may have the shape of an ellipse which is oriented in a radial direction, or the shape of a circle or polygon which has no directional orientation.

The input port 112 of a predetermined size is formed in the upper surface of the body of the drum 110 which is arranged horizontally so that food waste which is dehydrated and cut while passing through a hopper coupled to a sink (not shown) is put into the drum. Of course, the input port may also be formed in the upper surface of the drum 110 in a free-standing type food treatment system.

The elliptical discharge port 114 (see FIG. 7) oriented in the axial direction is provided in the bottom of the drum body, so that food waste which is completely dried by eliminating water using a high temperature heat source in the drum 110 is discharged through the discharge port.

The drum 110 is preferably manufactured through casting using a metal material having high heat conductivity. A stainless steel material is mainly used for the drum.

The stirring screw 120 is provided in the drum 110 in such a way as to rotate forwards or backwards, thus stirring and crushing the food waste which is input through the input port 112 into the drum 110.

Further, the stirring screw 120 may be provided in the axial or radial direction of the drum according to the shape of the drum 110. Of course, the stirring screw may be provided to increase crushing efficiency regardless of direction.

The stirring screw 120 is the rotary member which is constructed so that a plurality of rotary blades or a single blade 123 is mounted to the outer surface of the rod-shaped rotating shaft 125. One end of the rotating shaft 125 is connected to the power supply unit 130 provided on a front cap 150, while the other end is installed and supported in a shaft hole (not shown) of a rear cap 155.

In this case, a predetermined interval is defined between the inner surface of the drum 110 and the outer end of each rotary blade 123 of the stirring screw 120 such that the rotary blades 123 can rotate smoothly without interference.

Each rotary blade 123 has the shape of a hook such that it is bent at an end thereof, and is rotatably installed in the drum 110 to stir and crush the food waste which is input into the drum 110. The rotary blades 123 are provided on the rotating shaft 125.

Further, the rotary blades may be provided radially around the rotating shaft.

The rotary blades 123 may be provided such that space is defined between the rotary blades 123 and the hook-shaped ends of the rotary blades 123 face each other. The space is formed by cutting predetermined portions between the rotary blades 123 which are coupled into a single structure. Thereby, the end of each rotary blade 123 is formed to have the hook shape.

Each rotary blade 123 may be removably provided on the circumference of the rotating shaft 125. Thus, when a rotary blade 123 is broken or bent, the rotary blade 123 may be replaced with a new one, so that the stirring screw 120 can be used for a lengthy period of time.

If the stirring screw 120 having the rotary blades 123 which are constructed as described above is used, the accumulation of the food waste is prevented during the rotation of the rotary blades 123, and the motor 130 is not overloaded.

That is, some of food waste is discharged between the rotary blades 123, so that the food waste does not accumulate. The food waste is pulled into the drier by the hook-shaped ends of the rotary blades 123, and thereby the motor 130 is not overloaded.

The power supply unit 130 serves as a drive source for rotating the stirring screw 120 which is disposed in inner space of the drum 110 forwards and backwards. A motor may be used as the power supply unit 130.

A support bracket 166 is provided on the lower portion of the rear cap 155 to surround the lower end of the rear cap 155 and support the entire drier 100. In order to install the drier 100 in the main body of the food treatment system, a fastening member (not shown) may be fastened to holes which are formed in the support bracket 166 and have a predetermined size.

The heater 140 is provided on the outer surface of the drum 110 and provides heat of high temperature to the inner space of the drum 110 serving as the drying space, when electricity is applied to the heater, thus removing water from the food waste which is input into the inner space, and thereby completely drying the food waste.

Such a heater 140 comprises a heating plate which is attached to the outer surface of the drum 110 and has superior heat conductivity, and is electrically connected to an electric power supply unit 142. A sheath heater may be used as the heater 140.

FIG. 5 is a perspective view illustrating a crush unit 160 of the drier 100 of the food treatment system according to one embodiment of the present invention.

Referring to FIGS. 1 to 5, after the food waste is input into the inner space through the input port 112 of the drum 110, water is completely removed from the food waste by the heat source provided by the heater 140. Thereby, the dried food waste is fed to the discharge port 114 (see FIG. 7) while being stirred and crushed by the stirring screw 120.

Further, most of the food waste is discharged through the discharge port 114 (see FIG. 7) to the discharge box (not shown), but food waste which is not dried or some of the dried food waste adheres to the inner surface of the drum 110 and thereby remains in the drum. Particularly, when the stirring screw 120 is rotated backwards, so that the food waste is crushed by the crush unit 160, some of the food waste may stick to the surrounding area of the crush unit 160. Thereby, the power supply unit 130 for rotating the stirring screw 120 may be overloaded.

In order to solve the problem, the structure of the crush unit 160 may be modified.

The crush unit 160 according to the present invention includes a crush plate 162 which directly crushes food waste, and a crush plate support 165 which supports the crush plate.

The circular crush plate 162 is mounted to the inner wall of the drum 110 to which the power supply unit 130 and the stirring screw 120 are connected, and a plurality of crush blades 161 is obliquely provided on the circular crush plate 162 in a radial direction thereof. The arch-shaped crush plate support 165 is mounted to the upper portion of the crush plate 162.

The food waste fed by the stirring screw 120 may be crushed in a radial direction by the circular crush plate 162.

The crush plate support 165 has an arch shape. Thus, the crush plate support does not contact the outer ends of the rotary blades 123 of the stirring screw 120 even when the stirring screw 120 is rotated.

The crush plate support 165 includes a circular plate member 163 which is provided to surround the crush plate 162, and rib members 164 which are provided on the outer surface of the plate member 163 in a radial direction.

The rib members 164 support the plate member 163 in the radial direction, thus preventing the plate member 163 from being deformed even if a large amount of food waste adheres to the plate member.

Further, the crush plate support 165 may adjust the amount of the food waste fed to the crush plate 162, thus preventing damage to the crush unit 160 or the stirring screw 120 and preventing food waste caught in the crush unit 160 from adhering thereto, therefore preventing the power supply unit 130 from becoming overloaded.

A discharge box (not shown) may be provided under the drier 100 of the food treatment system to collect food waste which is discharged through the discharge port 114 (see FIG. 7).

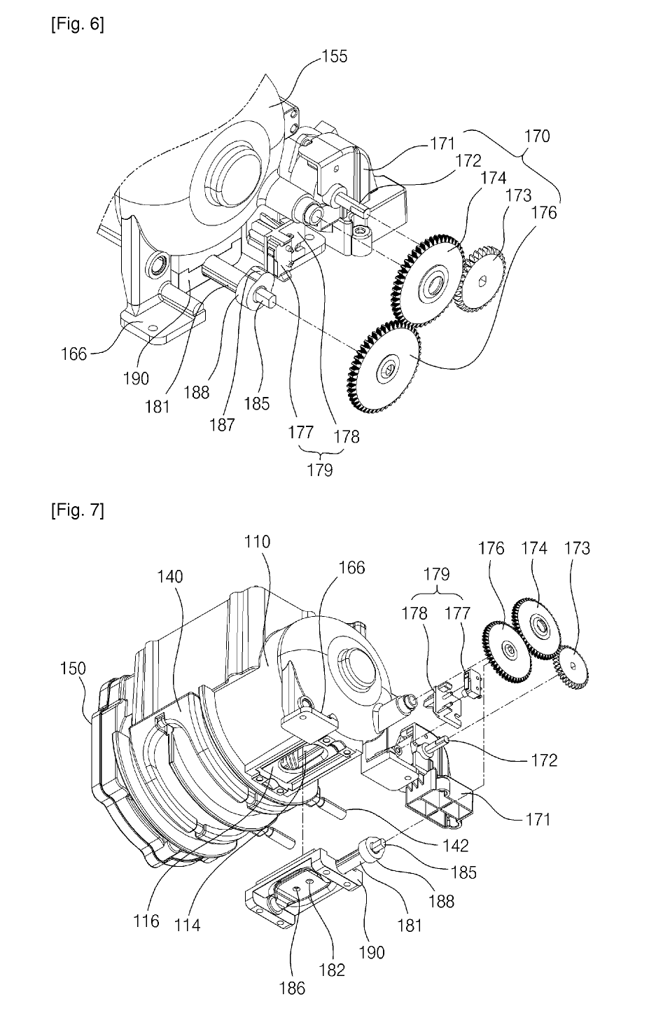

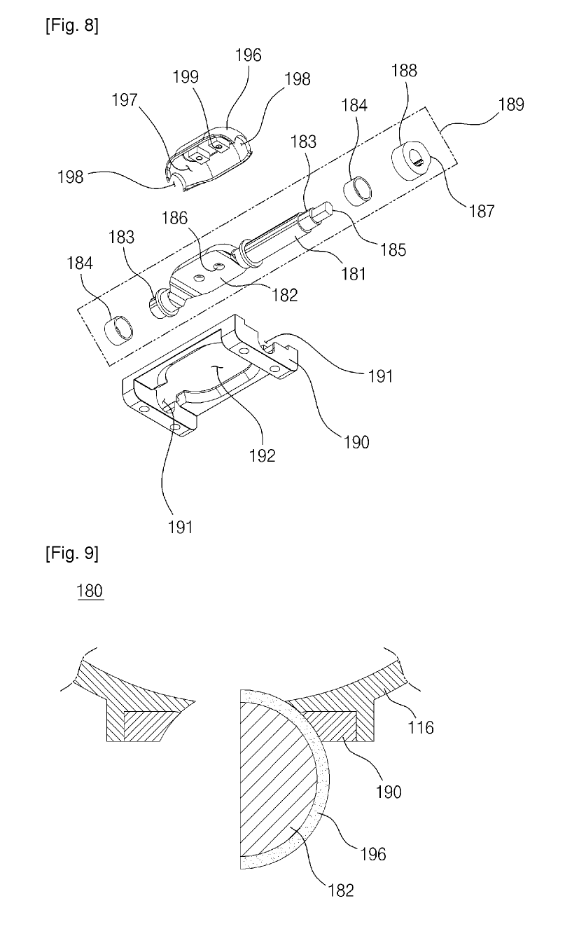

FIG. 6 is a perspective view illustrating parts around the discharge port of the drier 100 of the food treatment system according to one embodiment of the present invention, FIG. 7 is a bottom exploded perspective view illustrating the drier 100 of the food treatment system according to one embodiment of the present invention, and FIG. 8 is an exploded perspective view illustrating an exhaust valve apparatus according to one embodiment of the present invention.

As shown in FIGS. 6 to 8, the exhaust valve apparatus according to one embodiment of the present invention is mounted to the lower surface of the discharge port 114, thus controlling the discharge port 114 so that it is opened or closed according to the drying state of the inside of the drum 110.

Referring to FIGS. 6 to 8, the exhaust valve apparatus includes a shaft valve member 189, a valve cover 196, and a locking cover 190. The shaft valve member 189 includes a support shaft 181 having the shape of a rod which has a circular section, and a valve 182 which has a diameter larger than that of the support shaft 181, has the shape of a rod having a semi-circular section, and is connected at one end thereof to one end of the support shaft. A cam 188 is mounted to the other end of the support shaft 181 and has on a surface thereof a protrusion 187. The valve cover 196 has the shape of a ring having a semi-circular section, and includes a valve receiving cavity 197 to surround the curved part of the valve 182 and a fastening part 199 which is provided on the inner side of the valve receiving cavity 197. The locking cover 190 has on both ends thereof semi-circular concave grooves 191 to receive the support shaft 181 and the valve 182, with an opening 192 formed in the central portion of the locking cover to correspond to the discharge port 114 of the drier of the food treatment system.

As the valve unit used in the exhaust valve apparatus, various valve units including a spherical valve unit and a plate valve unit may be used, in addition to the shaft valve member. Of course, the shape of the discharge port and the valve cover, and the installation position or operating method of a power transmission member may be changed depending on the shape of the valve unit.

The valve 182 of the shaft valve member 189 may be sintered or coated with a Teflon material. Here, the valve 182 may have a thickness from 1 mm to 3 mm.

Further, the valve cover 196 is additionally provided to cover and protect the valve 182 without the necessity of coating the valve 182 of the shaft valve member 189. In the case of coating the valve, the coating may easily fall off, and in order to surmount this problem the valve cover is used. The valve cover 196 may be sintered or coated with a Teflon material. Here, the valve cover may have a thickness from 1 mm to 3 mm.

Insert grooves 198 are formed in both ends of the valve cover 196. The insert grooves allow the valve to be easily supported when the valve 182 with a semi-circular section is fitted into the valve cover 196. Further, a plurality of holes is bored through the fastening part 199 provided on the inner side of the valve receiving cavity 197 of the valve cover 196. Thus, when the valve 182 is covered with the valve cover 196, fastening holes 186 formed through the valve 182 of the shaft valve member 189 and holes formed in the fastening part 199 may be connected to each other. Fastening members such as bolts are fitted into the aligned holes so that the valve cover 196 is fastened to the valve 182.

Fitting parts 183 are provided on both ends of the shaft valve member 189, so that bushing members 184 may be additionally mounted to the shaft valve member via the fitting parts. The bushing members 184 are used to prevent the support shaft 181 and the valve 182 from being damaged, due to friction between the support shaft or the valve and a discharge port support part 116 when the entire shaft valve member 189 is rotated. Each bushing member 184 is mainly made of brass, but may be made of other materials.

A power transmission member is provided on the side of the exhaust valve apparatus, and includes a power supply unit 171, a drive gear 173 which is mounted on a drive shaft 172 of the power supply unit 171, a first driven gear 174 which operatively engages with the drive gear 173, and a second driven gear 176 which is operated in conjunction with the first driven gear 174. A motor is mainly used as the power supply unit 171.

Of course, a shaft unit which is directly connected to the power supply unit may be used as the power transmission member.

Referring to FIGS. 6 and 7, a gear insert part 185 provided on an end of the support shaft 181 is inserted into the central hole formed in the second driven gear 176. The shaft valve member 189 is rotated clockwise or counterclockwise, as the drive gear 173 and the first or second driven gear 174 or 176 rotate.

In this case, the movement of the valve 182 which opens or closes the discharge port 114 (see FIG. 7) is governed by the operation of the drive gear 173. That is, the rotating direction and rotating angle of the valve 182 are determined by the rotating direction and rotating angle of the drive gear 173. Of course, the rotating angle may be changed according to the gear ratio of the drive gear 173 to the driven gears 174 and 176, which can be appropriately selected and adjusted by a user as desired.

Here, a device for determining the rotating direction and rotating angle of the drive gear 173 is required. To this end, a sensor unit 179 having a micro sensor 177 and a bracket 178 may be further provided. The micro sensor functions to detect contact pressure with the protrusion 187 of the cam 188 when the cam 188 is rotated. The bracket 178 functions to support the micro sensor 177. Of course, sensors other than the micro sensor 177 may be used.

The most ideal operation of opening the valve 182 is to rotate the valve 182 clockwise to about 110°. To this end, the micro sensor 177 is provided to a side of the cam 188 to detect the pressure applied by the protrusion 187 which is provided on a surface of the cam 188. That is, when the cam 188 is rotated at a predetermined angle, so that the protrusion 187 presses the micro sensor 177, the micro sensor 177 transmits a contact signal to the control unit, thus stopping the operation of the shaft valve member 189. Further, after all of the dried food waste has been discharged through the discharge port 114 to the outside, the valve 182 is further rotated clockwise, thus closing the discharge port 114 (a clockwise rotation of about 250°).

Further, unless the exhaust valve apparatus is operated when a lot of food waste is caught in the surroundings of the valve 182, the micro sensor 177 does not detect the external pressure applied by the cam 188 even though a given time has elapsed. In this case, the valve 182 is operated in a direction where food waste is not caught by the control unit (not shown), so that the food waste is eliminated, and thereafter normal operation is performed.

The bracket 178 is provided on the lower portion of the rear cap 155 of the drum 110 to support the micro sensor 177. In order to support the micro sensor, the bracket 178 may be provided with ribs, so that the micro sensor 177 is fitted between the ribs.

The operation of the exhaust valve apparatus will be described below with reference to FIGS. 6 to 9. The exhaust valve apparatus is operated in response to a signal of the control unit (not shown) when food waste is dried in the drier 100 of the food treatment system. Normally, the valve 182 of the exhaust valve apparatus closes the discharge port 114. However, when the food waste is dried, the control unit operates the valve 182, thus rotating the valve at a predetermined angle (see FIG. 9). That is, the valve 182 of the shaft valve member 189 has a semi-cylindrical shape. Thus, when the valve is positioned to be parallel to the surrounding area of the discharge port 114, the valve closes the discharge port 114. However, when the valve is rotated at a predetermined angle, the discharge port 114 is opened.

In order to supply power to the shaft valve member 189, the drive gear 173 and the driven gears 174 and 176 which are operated by the power supply unit 171 are provided. The micro sensor 177 is provided to detect pressure applied by the protrusion 187 of the cam 188 which is operated as the second driven gear 176 rotates. The micro sensor 177 detects external pressure applied by the protrusion 187 of the cam 188, and the control unit (not shown) supplies proper power to the drive gear 172 in response to the detected signal.

When the discharge port 114 is opened, the food waste fed by the rotation of the stirring screw 120 is discharged through the discharge port 114 to the outside. In this case, both ends of the valve 182 are formed to be sharp, thus easily cutting the dried food waste, prior to discharging the food waste to the outside. Such a construction prevents the accumulation of the food waste, thus preventing the food waste from decaying and preventing the surroundings of the drier from becoming contaminated, therefore preventing damage to the drier.

Further, the rotary blades 123 of the stirring screw 120 are spaced apart from the valve 182 of the shaft valve member 189 by a predetermined interval. Thus, when the stirring screw 120 is rotated, the rotary blades 123 do not make contact with the valve 182 of the shaft valve member 189, so that the rotary blades are not damaged due to friction.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A food waste exhaust apparatus for a food treatment system, comprising:
a valve unit provided in a discharge port of the food treatment system to open or close the discharge port;
a power supply unit for supplying power to the valve unit to open or close the valve unit; and
a power transmission member provided between the power supply unit and the valve unit, for transmitting power supplied from the power supply unit to the valve unit.

2. The food waste exhaust apparatus according to claim 1, wherein the power transmission member is a rolling contact unit or a shaft unit.

3. The food waste exhaust apparatus according to claim 2, wherein the rolling contact unit is a gear.

4. The food waste exhaust apparatus according to claim 1, wherein the valve unit comprises a shaft valve member.

5. The food waste exhaust apparatus according to claim 1, wherein the valve unit is operated rotably by the power transmitted to the valve unit.

6. The food waste exhaust apparatus according to claim 5, wherein the valve unit is operated rotably in a vertical or horizontal direction relative to the power transmission member.

7. The food waste exhaust apparatus according to claim 1, wherein the power supply unit is a motor.

8. The food waste exhaust apparatus according to claim 1, further comprising a sensor unit for detecting a position of the valve unit.

9. A drier for a food treatment system, comprising:
a drum having an input port into which a food waste is put and a discharge port through which a dried food waste is discharged;
a stirring screw rotatably disposed in inner space of the drum, and comprising rotary blades for stirring and crushing the food waste put into the drum, and a rotating shaft for supporting the rotary blades;
a power supply unit provided on a side of the drum and providing power to the stirring screw to rotate the stirring screw;
a heater provided on an outer side of a drum body and providing high temperature heat to an inner space of the drum when electric power is applied to the heater, thus drying the food waste; and
an exhaust apparatus mounted to a lower surface of the discharge port and controlling opening and closing of the discharge port.

10. The drier according to claim 9, further comprising a crush unit provided on an inner wall of the drum to which the power supply unit and the stirring screw are connected, the crush unit including a circular crush plate having a plurality of crush blades which are obliquely provided on the circular crush plate in a radial direction thereof, and an arch-shaped crush plate support provided on an upper portion of the crush plate.

11. The drier according to claim 10, wherein the crush plate support comprises:
a circular plate member provided to surround the crush plate; and
a rib member provided on an outer surface of the plate member in a radial direction thereof.

12. The drier according to claim 9, wherein the rotary blades each have a hook shape and are arranged such that ends thereof face each other, with a space defined between the rotary blades.

13. The drier according to claim 9, wherein the rotary blades are detachably provided on a circumference of the rotating shaft.

14. The drier according to claim 9, wherein the exhaust apparatus comprises:
a valve unit provided in the discharge port of the food treatment system to open or close the discharge port;
a power supply unit for supplying power to the valve unit to open or close the valve unit; and
a power transmission member provided between the power supply unit and the valve unit, and transmitting power supplied from the power supply unit to the valve unit.

15. The drier according to claim 14, wherein the power transmission member is a rolling contact unit or a shaft unit.

16. The drier according to claim 15, wherein the rolling contact unit is a gear.

17. The drier according to claim 14, wherein the valve unit comprises a shaft valve member.

18. The drier according to claim 14, wherein the valve unit is operated rotably in a vertical or horizontal direction relative to the power transmission member.

19. The drier according to claim 14, wherein the power supply unit is a motor.

20. The drier according to claim 17, wherein the shaft valve member comprises:
a support shaft having a shape of a rod which has a circular section;
a valve having a diameter larger than that of the support shaft, and having a shape of a rod which has a semi-circular section, the valve connected at a first end thereof to a first end of the support shaft; and
a cam fitted over a second end of the support shaft, and having on a surface thereof a protrusion.

21. The drier according to claim 20, wherein the valve is formed by sintering a Teflon material.

22. The drier according to claim 20, wherein the valve is coated with Teflon.

23. The drier according to claim 21, wherein a thickness of the valve is in the range of 1˜3 mm.

24. The drier according to claim 20, further comprising:
a valve cover having a shape of a ring having a semi-circular section, and having a valve receiving cavity to surround a curved part of the valve, with a fastening part provided on an inner side of the valve receiving cavity; and
a locking cover having on both ends thereof semi-circular concave grooves to receive the support shaft and the valve, and having in a central portion thereof an opening portion to correspond to the discharge port.

25. The drier according to claim 24, wherein the valve cover is formed by sintering a Teflon material.

26. The drier according to claim 24, wherein the valve cover is coated with Teflon.

27. The drier according to claim 25, wherein a thickness of the valve cover is in the range of 1˜3 mm.

28. The drier according to claim 24, further comprising:
a bushing member provided on each of opposite ends of the shaft valve member.

29. The drier according to claim 20, wherein
the power transmission member comprises a drive gear mounted on a drive shaft of a power supply unit, and at least one driven gear operatively engaging with the drive gear, and
a gear insert part provided on an end of the support shaft is inserted into a center of the driven gear, so that the shaft valve member is driven rotably clockwise or counterclockwise according to rotation of the drive gear and the driven gear.

30. The drier according to claim 20, further comprising a sensor unit including:
a sensor for detecting contact pressure with the protrusion of the cam during rotation of the cam; and
a bracket for supporting the sensor.
